(19) United States
(12) Patent Application Publication
(10) Pub. No.: US 2025/0357849 A1
(43) Pub. Date: Nov. 20, 2025

(54) POWER TRANSISTOR CONTROL METHOD

(71) Applicant: CHENGDU ISMARTWARE MICROELECTRONICS CO., LTD., Chengdu (CN)

(72) Inventors: Zhijun CHEN, Chengdu (CN); Tong CHEN, Chengdu (CN)

(21) Appl. No.: 19/286,292

(22) Filed: Jul. 31, 2025

Related U.S. Application Data
(63) Continuation of application No. PCT/CN2024/112842, filed on Aug. 16, 2024.

(30) Foreign Application Priority Data
Sep. 26, 2023 (CN) 202311248786.4

(51) Int. Cl. H02M 1/15; H02M 1/08; H02M 3/335

(52) U.S. Cl. CPC H02M 1/15; H02M 1/08; H02M 3/33576

(57) ABSTRACT

Provided is a power transistor control method belonging to the field of switching power supplies. The method includes: obtaining a feedback voltage of a load corresponding to a power transistor, and obtaining at least one valley signal and a valley latching signal when the power transistor is turned off; determining, based on the feedback voltage, a corresponding off-time signal of the power transistor; when the feedback voltage decreases, determining a target valley position based on the off-time signal and the valley latching signal; when the feedback voltage increases, determining the target valley position based on the off-time signal and the at least one valley signal; and controlling the power transistor to be turned on at the target valley position.

### CROSS-REFERENCE TO RELATED APPLICATION

This application is a continuation of International Application No. PCT/CN2024/112842, filed on Aug. 16, 2024, which is submitted based on and claims priority to Chinese patent application No. 202311248786.4, filed on Sep. 26, 2023, the entire content of which is incorporated herein by reference.

### FIELD

The present disclosure relates to the field of switching power supply technologies, and more particularly, to a power transistor control method.

### BACKGROUND

When an input voltage or a load of a switching power supply changes, a power transistor will be turned on alternately at different valley positions to cause frequency jitter. The power transistor needs to be locked at a valley position to reduce the frequency jitter. In the related art, a method is existed for controlling the power transistor to be turned on through valley locking based on a feedback voltage and a switching frequency. When the feedback voltage changes greatly, this method cannot change the number of valleys in a switching cycle accordingly (also known as locking too tightly), which results in a lot of energy accumulation or lack of energy at an output end, and a phenomenon of skipping a plurality of valleys occurs, increasing output voltage ripple. In addition, when the input voltage changes greatly, the power transistor may be turned on and off between adjacent valleys repeatedly, which may easily cause device loss and reduce a service life of the device.

### SUMMARY

The present disclosure aims to solve one of the technical problems in the related art. To this end, the present disclosure provides a power transistor control method, a power transistor control system, and an electronic device that may accurately lock a valley, solving the technical problems of frequency jitter due to a change of voltage or load, and large voltage ripple caused by the valley being locked too tightly. Also, the power transistor is prevented from alternately being turned on at adjacent valleys due to a change of input voltage or the load, which reduces device loss and subsequently prolongs a service life of the device.

In a first aspect, the present disclosure provides a power transistor control method. The method includes: obtaining a feedback voltage of a load corresponding to a power transistor, and obtaining at least one valley signal and a valley latching signal in a target switching cycle when the power transistor is turned off, each of the at least one valley signal indicating that waveform resonance of a resonant voltage reaches a valley position, and the target switching cycle being determined based on the feedback voltage; determining, based on the feedback voltage, a corresponding off-time signal of the power transistor in the target switching cycle, the off-time signal including a first waveform signal and a second waveform signal, the second waveform signal being delayed by a target phase difference relative to the first waveform signal in the target switching cycle, and the target phase difference being determined based on the feedback voltage;

when the feedback voltage decreases, determining a target valley position based on a relationship between a start time point of at least one of the first waveform signal or the second waveform signal in the target switching cycle and a start time point of the valley latching signal in the target switching cycle; when the feedback voltage increases, determining the target valley position based on a relationship between the start time point of at least one of the first waveform signal or the second waveform signal in the target switching cycle and a start time point of each of the at least one valley signal in the target switching cycle; and controlling the power transistor to be turned on at the target valley position. With the power transistor control method according to an embodiment of the present disclosure, when the feedback voltage changes differently, whether an on-state position of the power transistor changes is determined based on the change of the start time point of different signals, and the valley may be accurately locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently prolongs the service life of the device.

In a second aspect, the present disclosure provides a power transistor control system based on the power transistor control method described in the first aspect. The power transistor control system includes: a valley detection module configured to output at least one valley signal; a valley counting module connected to the valley detection module, the valley counting module being configured to output a valley latching signal and a valley number at Turn-on corresponding to a target switching cycle; an off-time module configured to receive a feedback voltage, and output an off-time signal based on the feedback voltage; a valley on-state module connected to each of the valley detection module, the valley counting module, and the off-time module, the valley on-state module being configured to determine a target valley position; a power transistor; and a drive module electrically connected to each of the valley on-state module and the power transistor, the drive module being configured to control the power transistor to be turned on at the target valley position.

With the power transistor control system according to an embodiment of the present disclosure, the valley detection module, the valley counting module, the off-time module, the valley on-state module, and the drive module are provided in the power transistor control system, at least one valley signal in the target switching cycle may be obtained based on the valley detection module, and a valley latching signal may be obtained through the valley counting module. In this way, when the feedback voltage changes differently, whether the on-state position of the power transistor changes is determined based on the change of the start time point of different signals, and the valley may be accurately locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently extending the service life of the device.

In a third aspect, the present disclosure provides a power transistor control apparatus. The power transistor control apparatus includes: a first processing module configured to obtain a feedback voltage of a load corresponding to a power transistor, and obtain at least one valley signal and a valley latching signal in a target switching cycle in case of the power transistor is turned off, each of the at least one valley signal indicating that waveform resonance of a resonant voltage reaches a valley position, and the target switching cycle being determined based on the feedback voltage; a second processing module configured to determine, based on the feedback voltage, a corresponding off-time signal of the power transistor in the target switching cycle, the off-time signal including a first waveform signal and a second waveform signal, the second waveform signal being delayed by a target phase difference relative to the first waveform signal in the target switching cycle, and the target phase difference being determined based on the feedback voltage; a third processing module configured to, when the feedback voltage decreases, determine a target valley position based on a relationship between a start time point of at least one of the first waveform signal or the second waveform signal in the target switching cycle and a start time point of the valley latching signal in the target switching cycle; a fourth processing module configured to, when the feedback voltage increases, determine the target valley position based on a relationship between the start time point of at least one of the first waveform signal or the second waveform signal in the target switching cycle and a start time point of each of the at least one valley signal in the target switching cycle; and a fifth processing module configured to control the power transistor to be turned on at the target valley position.

With the power transistor control apparatus according to an embodiment of the present disclosure, when the feedback voltage changes differently, whether the on-state position of the power transistor changes is determined based on the change of the start time point of different signals, such as the first waveform signal V_{off_latch} and the second waveform signal V_{off_latch}, and the valley may be accurately locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently prolongs the service life of the device.

In a fourth aspect, the present disclosure provides an electronic device including a memory, a processor, and a computer program stored in the memory and executable by the processor. The processor, when executing the computer program, implements the power transistor control method described in the first aspect.

In a fifth aspect, the present disclosure provides a non-transitory computer-readable storage medium having a computer program stored thereon. The computer program, when executed by a processor, implements the power transistor control method described in the first aspect.

In a sixth aspect, the present disclosure provides a computer program product including a computer program. The computer program, when executed by a processor, implements the power transistor control method described in the first aspect.

The above-described one or more technical solutions in the embodiments of the present disclosure have at least one of the following technical effects.

When the feedback voltage changes, whether the on-state position of the power transistor changes is determined based on the change of the start time point of different signals, and the valley may be accurately locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently prolongs the service life of the device.

Further, the valley on-state position of the power transistor is adaptively adjusted based on change of the feedback voltage (i.e., change of the load). During a loop feedback adjustment process of a switching power supply, erratic valley switching will not occur when the feedback voltage fluctuates, which enables the valley to be well locked, and solves the technical problems of frequency jitter due to the change of the voltage or load, and the large voltage ripple caused by the valley being locked too tightly.

Additional aspects and advantages of the present disclosure will be provided in part in the following description, or in part will become apparent from the following description or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a first principle schematic diagram of a power transistor control method according to an embodiment of the present disclosure.

FIG. 2 is a second principle schematic diagram of a power transistor control method according to an embodiment of the present disclosure.

FIG. 3 is a third principle schematic diagram of a power transistor control method according to an embodiment of the present disclosure.

FIG. 4 is a fourth principle schematic diagram of a power transistor control method according to an embodiment of the present disclosure.

FIG. 5 is a fifth principle schematic diagram of a power transistor control method according to an embodiment of the present disclosure.

FIG. 6 is a sixth principle schematic diagram of a power transistor control method according to an embodiment of the present disclosure.

FIG. 7 is a seventh principle schematic diagram of a power transistor control method according to an embodiment of the present disclosure.

FIG. 8 is an eighth principle schematic diagram of a power transistor control method according to an embodiment of the present disclosure.

FIG. 9 is a ninth principle schematic diagram of a power transistor control method according to an embodiment of the present disclosure.

FIG. 10 is a tenth principle schematic diagram of a power transistor control method according to an embodiment of the present disclosure.

FIG. 11 is an eleventh principle schematic diagram of a power transistor control method according to an embodiment of the present disclosure.

FIG. 12 is a twelfth principle schematic diagram of a power transistor control method according to an embodiment of the present disclosure.

FIG. 13 is a thirteenth principle schematic diagram of a power transistor control method according to an embodiment of the present disclosure.

FIG. 14 is a fourteenth principle schematic diagram of a power transistor control method according to an embodiment of the present disclosure.

FIG. 15 is a first schematic flowchart of a power transistor control method according to an embodiment of the present disclosure.

FIG. 16 is a fifteenth principle schematic diagram of a power transistor control method according to an embodiment of the present disclosure.

FIG. 17 is a sixteenth principle schematic diagram of a power transistor control method according to an embodiment of the present disclosure.

FIG. 18 is a seventeenth principle schematic diagram of a power transistor control method according to an embodiment of the present disclosure.

FIG. 19 is a second schematic flowchart of a power transistor control method according to an embodiment of the present disclosure.

FIG. 20 is a schematic structural diagram of a power transistor control apparatus according to an embodiment of the present disclosure.

FIG. 21 is a schematic structural diagram of an electronic device according to an embodiment of the present disclosure.

### DETAILED DESCRIPTION

Technical solutions according to embodiments of the present disclosure will be described clearly below in combination with accompanying drawings of the embodiments of the present disclosure. Obviously, the embodiments described below are only a part of the embodiments of the present disclosure, rather than all embodiments of the present disclosure. On a basis of the embodiments of the present disclosure, all other embodiments obtained by those skilled in the art shall fall within the protection scope of the present disclosure.

It should be noted that terms “first” and “second” in the specification and claims of the present disclosure are used to distinguish similar objects, rather than to describe a specific sequence or order. It should be understood that data as used can be interchanged where appropriate, to enable the embodiments of the present disclosure described herein to be implemented in an order other than that illustrated or described herein. Also, the objects distinguished by the terms such as “first” and “second” are usually objects of the same type. The quantity of the objects is not limited. For example, one or a plurality of first objects may be provided. In addition, “and/or” throughout the specification and appended claims indicates at least one of the objects associated with “and/or”. The character “/” generally indicates that the associated objects before and after the character are in an “or” relationship.

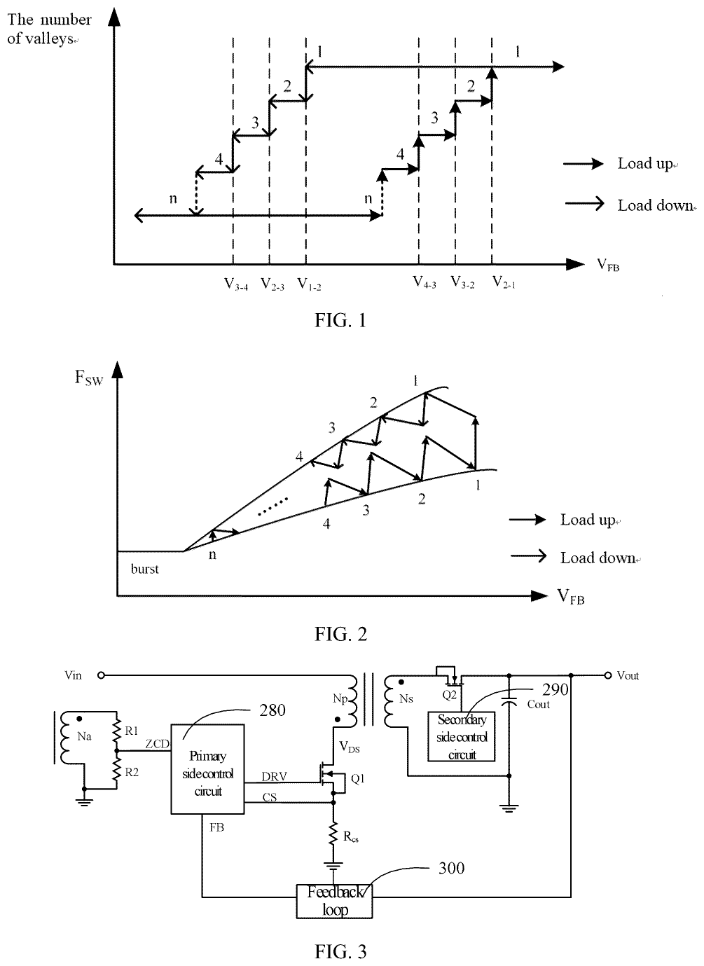

As illustrated in FIG. 1 to FIG. 19, a power transistor control method according to an embodiment of the present disclosure is described below.

It should be noted that an executor of the power transistor control method may be a power transistor control system, or may be a server electrically connected to the power transistor control system, or may be a power transistor control apparatus arranged in the power transistor control system, or may be a user terminal communicatively connected to the power transistor control system, including but not limited to a mobile terminal and a non-mobile terminal.

For example, the mobile terminal includes, but is not limited to, a mobile phone, a PDA smart terminal, a tablet computer, and an in-vehicle smart terminal. The non-mobile terminal includes, but is not limited to, a PC terminal and the like.

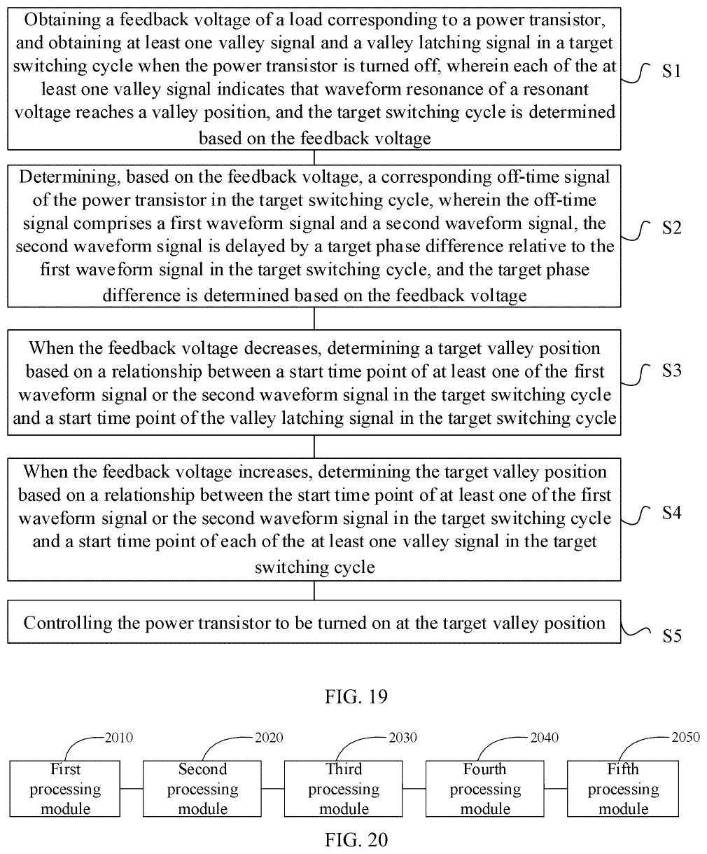

As illustrated in FIG. 19, the power transistor control method includes blocks S1, S2, S3, S4, and S5.

It should be noted that, the power transistor control method may be applied to a power transistor control system.

The power transistor control system may be a switching power supply.

The switching power supply is a high-frequency electric energy conversion apparatus, which is a type of power supply.

The switching power supply is used to convert a voltage of a certain level into a voltage or current required by a client side through different forms of architecture.

The switching power supply may be applied to the fields of fast charging, adapters, and chargers.

The power transistor control system may include a power transistor, primary side

winding inductance corresponding to the power transistor, or parasitic capacitance of a primary side power transistor.

At block S1, a feedback voltage of a load corresponding to a power transistor is obtained, and at least one valley signal and a valley latching signal in a target switching cycle are obtained when the power transistor is turned off. The valley signal indicates that waveform resonance of a resonant voltage reaches a valley position. The target switching cycle is determined based on the feedback voltage.

At this block, an operation state of the power transistor may include on-state or off-state.

The feedback voltage is a voltage fed back to a primary side circuit via an optocoupler.

The feedback voltage is positively correlated with the load. In an exemplary embodiment of the present disclosure, when the load increases, the feedback voltage increases; and when the load decreases, the feedback voltage decreases.

By detecting the feedback voltage, a change of the load may be detected.

A switching cycle may include on-time and demagnetization time.

The target switching cycle may be determined based on the feedback voltage.

The target switching cycle is a cycle during which the power transistor needs to be turned on currently.

When the feedback voltage decreases, the on-time and the demagnetization time also decrease, and the switching cycle decreases. When the feedback voltage increases, the on-time and the demagnetization time also increase, and the switching cycle increases.

When the switching cycle decreases, a switching frequency increases. When the switching cycle increases, the switching frequency decreases.

The switching cycle includes at least one valley signal.

When the number of valleys of the resonant voltage decreases, the demagnetization time decreases and the switching cycle decreases.

When the number of the valleys of the resonant voltage increases, the demagnetization time increases and the switching cycle increases.

The valley signal indicates that the waveform resonance of the resonant voltage reaches the valley position. That is, a position where the valley signal appears may indicate a position where a resonant valley is located. Operating waveform of the valley signal is illustrated in FIG. 6.

As illustrated in FIG. 6, in some embodiments, when a sampled voltage signal is less than a first voltage threshold, an inversion signal corresponding to the sampled voltage signal is obtained; based on the inversion signal, an intermediate pulse signal is obtained; and delay processing is performed on the intermediate pulse signal to obtain at least one valley signal.

In this embodiment, the sampled voltage signal may be a voltage corresponding to an auxiliary winding, as illustrated by V_{ZCD} in FIG. 6.

The first voltage threshold is illustrated by V_{ZCD-REF} in FIG. 6. The first voltage threshold may be user-defined, which is not limited in the present disclosure.

The sampled voltage signal may include a high-level signal and a low-level signal.

The inversion signal may include a high-level signal and a low-level signal, as illustrated by V_{ZCD-FALL} in FIG. 6.

The high-level signal of the inversion signal corresponds to the low-level signal of the sampled voltage signal. The low-level signal of the inversion signal corresponds to the high-level signal of the sampled voltage signal.

The intermediate pulse signal may be determined based on a rising edge of the inversion signal.

The intermediate pulse signal may be delayed to a valley position of the resonant voltage by performing the delay processing on the intermediate pulse signal.

At least one valley signal may be obtained by performing the delay processing on the intermediate pulse signal, as illustrated by valley in FIG. 6.

The target switching cycle may include at least one valley signal.

The valley latching signal may be determined based on the number of at least one valley signal in the target switching cycle and the number of at least one valley signal in a previous cycle of the target switching cycle.

In some embodiments, obtaining the at least one valley signal and the valley latching signal in the target switching cycle may include: obtaining a first quantity corresponding to the at least one valley signal in the target switching cycle and a second quantity corresponding to at least one valley signal in the previous cycle of the target switching cycle; and obtaining the valley latching signal when the first quantity is equal to the second quantity.

In this embodiment, one switching cycle may include at least one valley signal. For example, one switching cycle may include three valley signals, or may include four valley signals, which is not limited in the present disclosure.

The first quantity may be equal to the second quantity, or may not be equal to the second quantity.

The first quantity indicates the number of valley signals included in the target switching cycle, that is, the number of valleys of the resonant voltage in the target switching cycle.

The second quantity indicates the number of the valley signals included in the previous cycle of the target switching cycle, that is, the number of the valleys of the resonant voltage in the previous cycle of the target switching cycle.

When the first quantity is equal to the second quantity, the valley latching signal may be obtained.

In some embodiments, subsequent to obtaining the feedback voltage of the load corresponding to the power transistor, the power transistor control method further includes: obtaining an off-signal when a first voltage signal corresponding to a primary side current is greater than the feedback voltage; and controlling the power transistor to be turned off based on the off-signal.

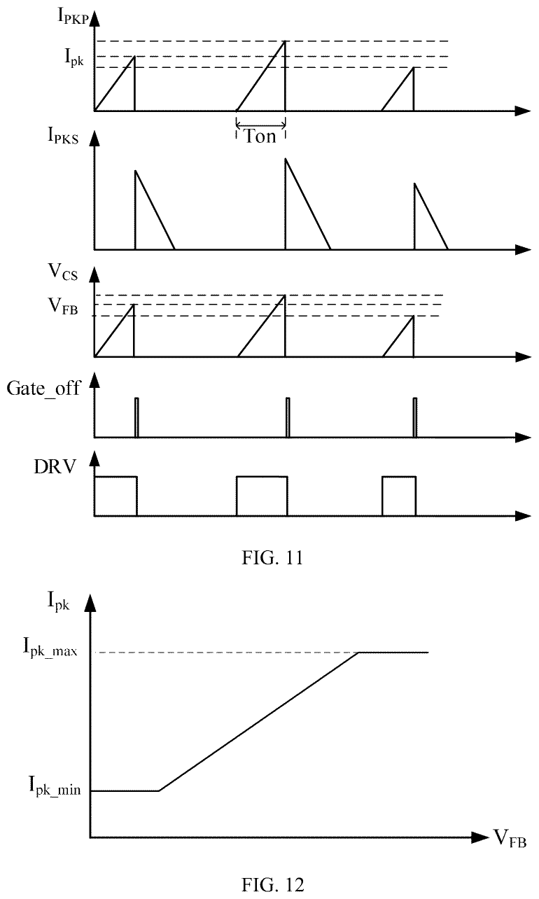

In this embodiment, the primary side current is a current signal corresponding to the primary side circuit, as illustrated by I_{PKP} in FIG. 11.

The first voltage signal is a voltage signal corresponding to the primary side current, as illustrated by V_{CS} in FIG. 11.

When the first voltage signal is greater than the feedback voltage, the off-signal may be obtained.

The off-signal is used to control the power transistor to be turned off.

Based on the off-signal, a driving voltage signal may be controlled to a low level, controlling the power transistor to be turned off.

In some embodiments, when the power transistor is turned off and a secondary side current is 0, a LC circuit formed by the primary side winding inductance corresponding to the power transistor and the parasitic capacitance of the primary side power transistor begins to resonate.

In this embodiment, when the power transistor is turned off, the secondary side current decreases. When the secondary side current decreases to 0, the LC circuit formed by the primary side winding inductance and the parasitic capacitance of the primary side power transistor begins to resonate.

When the feedback voltage changes, the primary side current also changes. The change of the primary side current is positively correlated with the change of the feedback voltage.

As illustrated in FIG. 12, when the feedback voltage increases, the primary side current also increases. When the feedback voltage decreases, the primary side current also decreases.

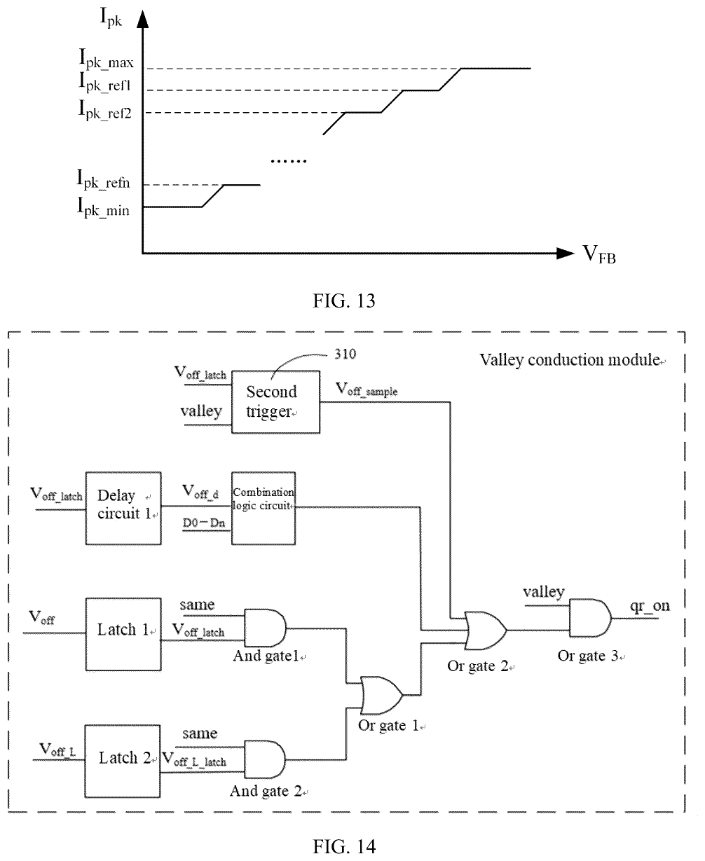

A middle part of the function defining the correspondence between the primary side current and the feedback voltage may be a straight line, as illustrated in FIG. 12. Additionally, the function for the middle part may be piecewise processed, as illustrated in FIG. 13.

At block S2, based on the feedback voltage, a corresponding off-time signal of the power transistor in the target switching cycle is determined. The off-time signal includes a first waveform signal and a second waveform signal. The second waveform signal is delayed by a target phase difference relative to the first waveform signal in the target switching cycle. The target phase difference is determined based on the feedback voltage.

At this block, the change of off-time may be inversely proportional to the change of the feedback voltage.

For example, when the feedback voltage increases, the off-time decreases. When the feedback voltage decreases, the off-time increases.

An off-time signal may be output based on the magnitude of the feedback voltage.

When the load becomes heavier, the feedback voltage increases, the off-time shortens, and the switching frequency increases. When the load becomes lighter, the feedback voltage decreases, the off-time lengthens, and the switching frequency decreases.

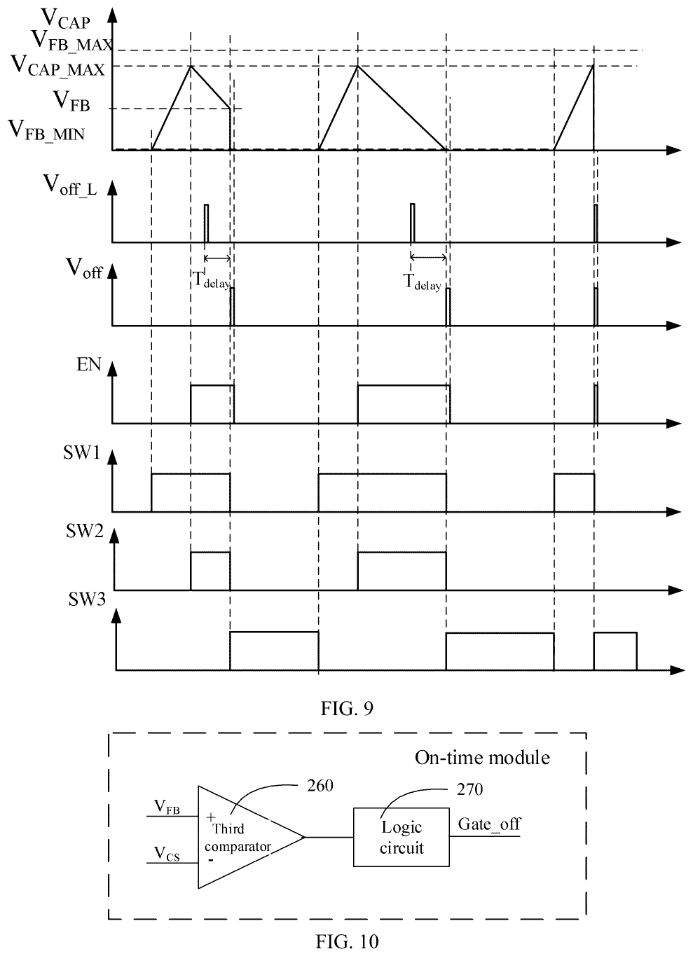

As illustrated in FIG. 9, when the feedback voltage V_{FB} continuously decreases to V_{FB_MIN}, the off-time is the longest and the longest off-time indicates a lowest frequency limit. A minimum off-time is determined based on V_{CAP_MAX}, and the minimum off-time indicates a maximum frequency limit.

Continuing to refer to FIG. 9, the off-time signal may include the first waveform signal and the second waveform signal.

The second waveform signal V_{off} is delayed by a target phase difference T_{delay} relative to the first waveform signal V_{off_L} in the target switching cycle.

The target phase difference indicates delay time between the second waveform signal and the first waveform signal.

The target phase difference may be a target multiple of a resonant cycle. The target multiple may be any value ranging from 0.5 to 3. For example, the target multiple may be 2, and the target phase difference may be twice the resonant cycle. The target multiple may be 1.5, and the target phase difference may be 1.5 times the resonant cycle.

The resonant cycle may be determined based on the primary side winding inductance corresponding to the power transistor and the parasitic capacitance of the primary side power transistor.

For example, the resonant cycle may be determined based on the following formula:

$${T}_{ring} = 2 π \sqrt{{L}_{p} {C}_{ds}} ,$$

where T_{ring} represents the resonant cycle, Lₚ represents the primary side winding inductance, and C_{ds} represents the parasitic capacitance of the primary side power transistor.

In a switching power supply with a maximum switching frequency of 100 KHz, the resonant cycle may be 1.6 μs. When the resonant cycle is 1.6 μs, the target phase difference may be set to 3.2 μs.

In some embodiments, the target phase difference may be determined based on the feedback voltage. When the feedback voltage increases, the target phase difference decreases. When the feedback voltage decreases, the target phase difference increases.

In this embodiment, at a valley where the first valley signal is located, the load is the largest, that is, when the feedback voltage is the largest, the target phase difference may be 0, that is, the first waveform signal coincides with the second waveform signal.

When the feedback voltage increases, the delay time between the first waveform signal and the second waveform signal decreases. When the feedback voltage decreases, the delay time between the first waveform signal and the second waveform signal increases.

At block S3, when the feedback voltage decreases, a target valley position is

determined based on a relationship between a start time point of at least one of the first waveform signal or the second waveform signal in the target switching cycle and a start time point of the valley latching signal in the target switching cycle.

At this block, a start time point of the first waveform signal in the target switching cycle is a time point at which the first waveform signal appears in the target switching cycle.

A start time point of the second waveform in the target switching cycle is a time point at which the second waveform signal appears in the target switching cycle.

A start time point of the valley latching signal in the target switching cycle is a time point at which the valley latching signal appears in the target switching cycle.

The start time point of the first waveform signal in the target switching cycle may be earlier than the start time point of the valley latching signal in the target switching cycle. Or, the start time point of the first waveform signal in the target switching cycle may be later than the start time point of the valley latching signal in the target switching cycle.

The start time point of the second waveform signal in the target switching cycle may be earlier than the start time point of the valley latching signal in the target switching cycle. Or, the start time point of the second waveform signal in the target switching cycle may be later than the start time point of the valley latching signal in the target switching cycle.

When the feedback voltage decreases, the target valley position may be determined based on the relationship between the start time point of at least one of the first waveform signal or the second waveform signal in the target switching cycle and the start time point of the valley latching signal in the target switching cycle.

At block S4, when the feedback voltage increases, the target valley position is determined based on a relationship between the start time point of at least one of the first waveform signal or the second waveform signal in the target switching cycle and a start time point of each of the at least one valley signal in the target switching cycle.

At this block, the number of the at least one valley signal may be one or more.

When the feedback voltage increases, the start time point of at least one of the first waveform signal or the second waveform signal in the target switching cycle may be earlier than the start time point of the target valley signal among the at least one valley signal in the target switching cycle. Or, the start time point of at least one of the first waveform signal or the second waveform signal in the target switching cycle may be later than the start time point of the target valley signal in the target switching cycle.

When the feedback voltage increases, the target valley position may be determined based on the relationship between the start time point of at least one of the first waveform signal or the second waveform signal in the target switching cycle and the start time point of each of the at least one valley signal in the target switching cycle.

The target valley position indicates an on-state position of the power transistor.

When the power transistor is not turned on, the switching power supply operates at an initial on-state valley, and the target valley position may be the same as or different from a position at which the initial on-state valley is located.

When the feedback voltage is different, the target valley position may be different.

At block S5, the power transistor is controlled to be turned on at the target valley position.

At this block, the target valley position is the on-state position of the power transistor.

In some embodiments, the block S5 may include: obtaining a valley on-state signal at the target valley position; and controlling the power transistor to be turned on based on the valley on-state signal.

In this embodiment, the valley on-state signal is used to control the driving voltage to be a high level, and then drive the power transistor to be turned on based on the driving voltage.

During a research and development process, the inventors discovered that in the related art, a method is existed for controlling the power transistor to be turned on through valley locking based on the feedback voltage and the switching frequency. When the feedback voltage changes greatly, this method cannot change the number of valleys in a switching cycle accordingly (also known as locking too tightly), which results in a lot of energy accumulation or lack of energy at an output end, and a phenomenon of skipping a plurality of valleys occurs, increasing output voltage ripple. In addition, when the input voltage changes greatly, the power transistor may be turned on and off between adjacent valleys repeatedly, which may easily cause device loss and reduce a service life of the device.

In the present disclosure, when the feedback voltage changes differently, whether the on-state position of the power transistor changes is determined based on the change of the start time point of different signals. When the feedback voltage decreases, the on-state position of the power transistor is determined based on the start time point of the first waveform signal and the second waveform signal in the target switching cycle and the start time point of the valley latching signal in the target switching cycle. When the feedback voltage increases, the on-state position of the power transistor is determined based on the start time point of the first waveform signal and the second waveform signal in the target switching cycle and the start time point of the valley signal in the target switching cycle. When the feedback voltage changes, the power transistor may be accurately turned on and the on-state valley may be locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently prolongs the service life of the device.

In some embodiments, the block S3 may include: when the feedback voltage decreases, prolonging off-time, and shifting backward the start time point of at least one of the first waveform signal or the second waveform signal in the target switching cycle; and determining the target valley position based on a relationship between a start time point of at least one of a backward-shifted first waveform signal or a backward-shifted second waveform signal in the target switching cycle and the start time point of the valley latching signal in the target switching cycle.

In this embodiment, the off-time changes as the feedback voltage.

When the feedback voltage decreases, the off-time is prolonged.

When the off-time is prolonged, the start time point of at least one of the first waveform signal or the second waveform signal is shifted backward in the target switching cycle.

When the feedback voltage decreases, the target valley position may be determined based on the relationship between the start time point of at least one of the backward-shifted first waveform signal or the backward-shifted second waveform signal in the target switching cycle and the start time point of the valley latching signal in the target switching cycle.

As illustrated in FIG. 16, in some embodiments, determining the target valley position based on the relationship between the start time point of at least one of the backward-shifted first waveform signal or the backward-shifted second waveform signal in the target switching cycle and the start time point of the valley latching signal in the target switching cycle may include: when a valley number at Turn-on corresponding to the target switching cycle is n, n being an integer greater than or equal to 1, and when the start time point of at least one of the first waveform signal or the second waveform signal in the target switching cycle is prior to the valley latching signal, determining a valley position corresponding to an n-th valley signal among n valley signals as the target valley position, the valley corresponding to the n-th valley signal being an initial on-state valley of a switching power supply; and when the valley number at Turn-on corresponding to the target switching cycle changes from n to n+1, and when the start time point of at least one of the first waveform signal or the second waveform signal in the target switching cycle is subsequent to the valley latching signal, determining a valley position corresponding to an (n+1)-th valley signal among n+1 valley signals as the target valley position, and latching the valley.

In this embodiment, the valley number at Turn-on corresponding to the target switching cycle is the number of valleys of the switching power supply being turned on in a current cycle.

As illustrated in FIG. 1, when the valley number at Turn-on changes, the feedback voltage also changes.

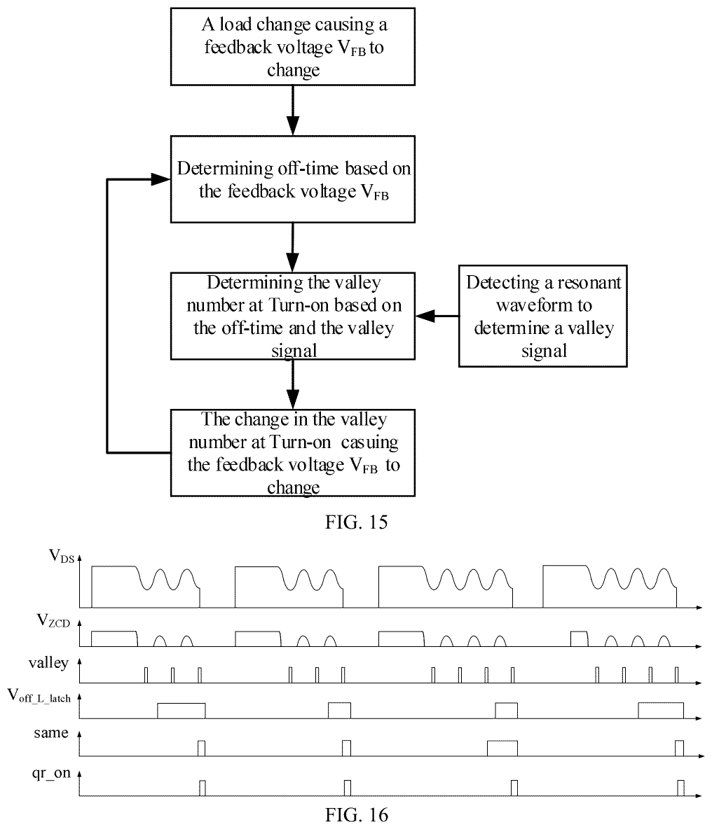

As illustrated in FIG. 15, when the valley number at Turn-on changes, the feedback voltage changes. A new feedback voltage may be obtained based on the valley number at Turn-on, and the off-time may be determined based on an updated feedback voltage.

When the feedback voltage changes, the off-time signal also changes.

For example, when the feedback voltage changes, a start time point of the off-time signal in the target switching cycle changes.

When the feedback voltage decreases, the start time point of the off-time signal in the target switching cycle is delayed.

In this embodiment, as illustrated in FIG. 16, when the load becomes lighter and the feedback voltage decreases, the off-time will be prolonged, and the start time point of the first waveform signal V_{off_L_latch} in the target switching cycle may be delayed from the position subsequent to the first valley signal to the position subsequent to the second valley signal.

In this embodiment, the n may be set to 3, as illustrated in FIG. 16. At the beginning, the switching power supply operates at a valley position corresponding to a third valley signal, and the valley number at Turn-on is 3.

When the feedback voltage decreases, the start time point of the first waveform signal V_{off_L_latch} in the target switching cycle is delayed from the position subsequent to the first valley signal to the position subsequent to the second valley signal. At this time, the valley latching signal does not change, and the target valley position is still the valley position corresponding to the third valley signal.

When the start time point of the first waveform signal V_{off_L_latch} is delayed from the position subsequent to the second valley signal to the position subsequent to the third valley signal in the target switching cycle, the power transistor jumps to a fourth valley and is turned on at the fourth valley. At this time, the valley latching signal has a high level at the valley position corresponding to the third valley signal, but the first waveform signal V_{off_L_latch} does not exist at the valley position corresponding to the third valley signal (the first waveform signal V_{off_L_latch} moves to the position subsequent to the third valley signal), and an AND gate 2 outputs a low level.

The valley latching signal remains at a high level until the first waveform signal V_{off_L_latch} appears at the position subsequent to the valley position corresponding to the third valley signal. The AND gate 2 outputs a high level, and both OR gate 1 and OR gate 2 also output a high level. At a valley position corresponding to a fourth valley signal, both the valley signal and the OR gate 2 are at the high level, so the valley position corresponding to the fourth valley signal is determined as the target valley position. In this way, a valley on-state signal is generated at the target valley position, the power transistor is turned on at the valley position corresponding to the fourth valley signal to complete valley switching, and the valley corresponding to the fourth valley signal is latched.

In some embodiments, subsequent to determining the valley position corresponding to the (n+1)-th valley signal among the n+1 valley signals as the target valley position, and latching the valley corresponding to the (n+1)-th valley signal, the power transistor control method further includes: when the feedback voltage increases, the valley number at Turn-on is n+1, and the start time point of the first waveform signal in the target switching cycle is prior to the valley latching signal, determining the valley position corresponding to the (n+1)-th valley signal as the target valley position

In this embodiment, the n may be set to 3. As illustrated in FIG. 16, subsequent to latching a valley corresponding to the fourth valley signal, the valley number at Turn-on corresponding to the target switching cycle changes from 3 to 4.

When the valley number at Turn-on corresponding to the target switching cycle changes from 3 to 4, in loop feedback adjustment of the switching power supply, the off-time becomes longer and the switching frequency decreases. In addition, through a feedback loop of the switching power supply, a primary side peak current Iₚₖ is increased, in such a manner that the feedback voltage V_{FB} increases, resulting in a decrease in the off-time T_{off}. In this way, the start time point corresponding to the first waveform signal V_{off_L_latch} returns to a point prior to the valley position corresponding to the third valley signal.

The valley latching signal only becomes high and the AND gate 2 outputs a high level at the valley position corresponding to the fourth valley signal. The valley position corresponding to the fourth valley signal is determined as the target valley position, and the valley remains unchanged.

In the present disclosure, when the number of the valleys changes, the valley number at Turn-on is latched, in such a manner that in feedback adjustment of the switching power supply, erratic valley switching will not occur when the feedback voltage fluctuates, achieving the valley locking.

As illustrated in FIG. 14, execution logic of turning on the power transistor when the feedback voltage decreases is described below.

In this embodiment, the first waveform signal is input into a latch 2, in such a manner that a first latching signal corresponding to the first waveform signal output by the latch 2 may be obtained. At a time point corresponding to a second target valley signal (at the second target valley signal or when the second target valley signal appears), when both the first latching signal and the valley latching signal exist, the AND gate 2 may output a high-level signal.

The second waveform signal is input into a latch 1, in such a manner that a second latching signal corresponding to the second waveform signal output by the latch 1 may be obtained. At a time point corresponding to the second target valley signal, when both the second latching signal and the valley latching signal exist, AND gate 1 may output a high-level signal.

An output terminal of the AND gate 1 and an output terminal of the AND gate 2 are respectively connected to input terminals of the OR gate 1.

When at least one of the AND gate 1 or the AND gate 2 outputs a high-level signal, the OR gate 1 may output a high-level signal. As a result, the OR gate 2 outputs a high-level signal.

When two input terminals of an AND gate 3 are at a high level, the target valley position is determined, and the AND gate 3 outputs a valley on-state signal qr_on at the target valley position.

In some embodiments, the block S4 may include: when the feedback voltage increases, shortening the off-time, and shifting forward the start time point of the first waveform signal in the target switching cycle and the start time point of the second waveform signal in the target switching cycle; and determining the target valley position based on a relationship between a start time point of at least one of a forward-shifted first waveform signal or a forward-shifted second waveform signal in the target switching cycle and the start time point of each of the at least one valley signal in the target switching cycle.

In this embodiment, when the feedback voltage increases, the start time point of the off-time signal in the target switching cycle is advanced.

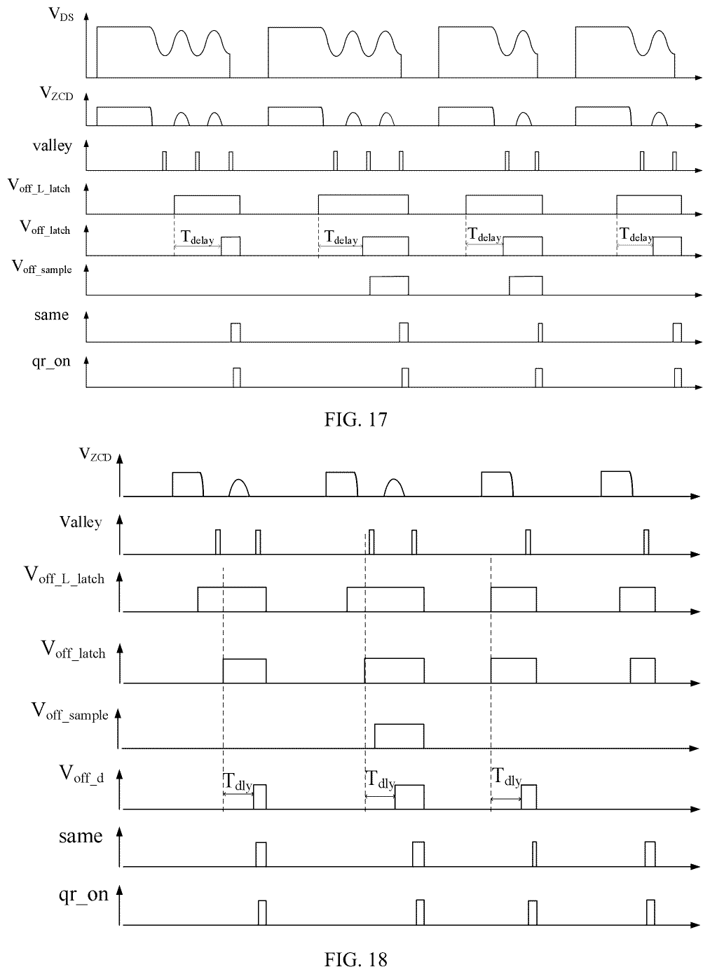

As illustrated in FIG. 17, when the load becomes heavier and the feedback voltage increases, the off-time will be shortened, and the start time point of the first waveform signal V_{off_L_latch} in the off-time signal in the target switching cycle may be advanced from the position subsequent to the first valley signal to the position prior to the first valley signal, and the start time point of the second waveform signal V_{off_L_latch} in the off-time signal in the target switching cycle may be advanced from the position prior to the third valley signal to the position prior to the second valley signal.

When the start time point of the off-time signal in the target switching cycle is changed, an updated off-time signal may be obtained.

In some embodiments, determining the target valley position based on the relationship between the start time point of at least one of the forward-shifted first waveform signal or the forward-shifted second waveform signal in the target switching cycle and the start time point of each of the at least one valley signal in the target switching cycle may include: when the valley number at Turn-on corresponding to the target switching cycle is m+1, m being an integer greater than or equal to 1, and when the start time point of the first waveform signal in the target switching cycle is prior to an (m-1)-th valley signal among m+1 valley signals, and the start time point of the second waveform signal in the target switching cycle is subsequent to the (m-1)-th valley signal, determining a valley position corresponding to an (m+1)-th valley signal among the m+1 valley signals as the target valley position, the valley corresponding to the (m+1)-th valley signal being an initial on-state valley of the switching power supply; and when the valley number at Turn-on corresponding to the target switching cycle changes from m+1 to m, and when the start time points of the first waveform signal and the second waveform signal in the target switching cycle are both prior to the (m-1)-th valley signal, determining a valley position corresponding to an m-th valley signal among m valley signals as the target valley position, and latching the valley corresponding to the m-th valley signal.

In this embodiment, as illustrated in FIG. 17, the m may be set to 2. At the beginning, the valley number at Turn-on is 3, the switching power supply operates at the third valley, and the target valley position is at the position at which the third valley is located.

When the feedback voltage increases, the off-time continuously shortens.

When the start time point of the first waveform signal V_{off_L_latch} is advanced from the position subsequent to the first valley to the position prior to the first valley, the start time point of the second waveform signal V_{off_L_latch} is subsequent to the first valley, and the valley latching signal is located at the third valley, the target valley position is still the third valley position, and the valley remains unchanged.

When the start time point of the second waveform signal V_{off_L_latch} is also prior to the first valley, the valley number at Turn-on in the target switching cycle changes to 2. At a falling edge of the first valley signal, a second trigger may output a signal V_{off_sample}, and the OR gate 2 also outputs a high-level signal. At a valley position corresponding to the second valley signal, the valley signal exists and an output of the OR gate 2 is a high-level signal. The valley position corresponding to the second valley signal is determined as the target valley position. The power transistor is turned on at the second valley position to complete the valley switching, and the valley corresponding to the second valley signal is latched.

In some embodiments, subsequent to determining the valley position corresponding to the m-th valley signal among the m valley signals as the target valley position, and latching the valley corresponding to the m-th valley signal, the power transistor control method may further include: determining the valley position corresponding to the m-th valley signal as the target valley position when the feedback voltage decreases, the valley number at Turn-on is m, the start time point of the first waveform signal in the target switching cycle is prior to the (m-1)-th valley signal among the m valley signals, and the start time point of the second waveform signal in the target switching cycle is subsequent to the (m-1)-th valley signal among the m valley signals.

In this embodiment, the m may be set to 2. When the valley corresponding to the second valley signal is latched, the valley number at Turn-on corresponding to the target switching cycle changes from 3 to 2, and the switching frequency increases. In the loop feedback adjustment of the switching power supply, the primary side peak current Iₚₖ will decrease, in such a manner that the feedback voltage V_{FB} decreases, resulting in an increase in the off-time T_{off}. In this way, the start time point of the second waveform signal V_{off_latch} returns to the position subsequent to the valley corresponding to the first valley signal.

The valley latching signal same is at a high level at the second valley, and the target valley position is still at the second valley, i.e., the valley number at Turn-on remains unchanged.

When the start time point of the first waveform signal V_{off_L_latch} returns to the position subsequent to the second valley, similar to the execution logic when the feedback voltage decreases in the above embodiments, the valley locking may also be achieved.

As illustrated in FIG. 14, execution logic of turning on the power transistor when the feedback voltage increases is described below.

As illustrated in FIG. 14, the second waveform signal V_{off_latch} is input into the latch 1, in such a manner that the second latching signal corresponding to the second waveform signal V_{off_latch} output by the latch 1 may be obtained. When the second latching signal corresponding to the second waveform signal is input into the second trigger, the second trigger samples at a falling edge of the valley signal valley. When the falling edge of the valley signal valley arrives, the second trigger outputs a signal V_{off_sample}.

The signal V_{off_sample} may be input to the OR gate 2, in such a manner that the OR gate 2 may output a high-level signal subsequent to detecting the signal V_{off_sample}.

When the two input terminals of AND gate 3 are at the high level, the target valley position is determined, and the AND gate 3 outputs the valley on-state signal qr_on at the target valley position.

In some embodiments, the second trigger is reset to 0 during the on-state of the power transistor, and the signal V_{off_sample} may be input to the OR gate 2.

As illustrated in FIG. 18, in some embodiments, the block S4 may further include: obtaining a delay signal corresponding to the second waveform signal; when the valley number at Turn-on corresponding to the target switching cycle is 2, and a start time point of the delay signal in the target switching cycle is prior to the valley position corresponding to the second valley signal, determining the valley position corresponding to the second valley signal as the target valley position, the valley corresponding to the second valley signal being an initial on-state valley of the switching power supply; and when the valley number at Turn-on corresponding to the target switching cycle changes from 2 to 1, and the start time point of the delay signal in the target switching cycle is prior to a valley position corresponding to a first valley signal, determining the valley position corresponding to the first valley signal as the target valley position, and latching the target valley position.

In this embodiment, a delay signal V_{off_d} corresponding to the second waveform signal V_{off_latch} may be obtained. The delay signal V_{off_d} may be delayed by half a resonant cycle relative to the second waveform signal V_{off_latch}.

When the valley number at Turn-on corresponding to the target switching cycle is 2, the initial on-state valley of the switching power supply is the valley corresponding to the second valley signal. At the beginning, the start time point of the first waveform signal V_{off_L_latch} is prior to the first valley, and the target valley position is the valley position corresponding to the second valley signal.

When the feedback voltage increases, the off-time T_{off} is shortened, the start

time point of the second waveform signal V_{off_latch} is prior to the valley position corresponding to the first valley signal, the delay signal V_{off_d} corresponding to the second waveform signal V_{off_latch} is prior to the valley position corresponding to the second valley signal, the valley latching signal same remains unchanged, and the target valley position is still the valley position corresponding to the second valley signal, that is, the valley on-state position is not changed.

When the number of the valleys in the target switching cycle changes from 2 to 1,

and the start time point of the delay signal V_{off_d} in the target switching cycle is prior to the valley position corresponding to the first valley signal, a combination logic circuit 1 may output a high-level signal, and the OR gate 2 also outputs a high-level signal. When the first valley signal exists and the AND gate 3 also outputs a high-level signal, the valley position corresponding to the first valley signal may be determined as the target valley position, and the power transistor is controlled to be turned on at the first valley, completing the valley switching, and the valley corresponding to the first valley signal is latched.

When the valley number at Turn-on corresponding to the target switching cycle changes from 2 to 1, in the loop feedback adjustment of the switching power supply, the switching frequency F_{SW} increases, the feedback voltage V_{FB} decreases, the off-time T_{off} increases, the valley latching signal same remains unchanged, and the valley number at Turn-on remains unchanged, that is, the target valley position is still the valley position corresponding to the first valley signal.

As illustrated in FIG. 14, the execution logic of turning on the power transistor when the feedback voltage increases and the valley number at Turn-on is 1 is described below.

The second waveform signal V_{off_latch} is input into the latch 1, in such a manner that the second latching signal corresponding to the second waveform signal V_{off_latch} output by the latch 1 may be obtained. Subsequently, the second latching signal is input into a delay circuit 1, in such a manner that the delay signal V_{off_d} corresponding to the second waveform signal V_{off_latch} output by the delay circuit 1 may be obtained.

The valley number at Turn-on in the target switching cycle may be obtained. When a valley counting signal D0-Dn indicates that the valley number at Turn-on of the target switching cycle is 1, the delay signal V_{off_d} and the valley counting signal are input into a combination logic circuit 1 and a high-level signal output by the combination logic circuit 1 is obtained. When the OR gate 2 detects the high-level signal output by the combination logic circuit 1, the OR gate 2 outputs a high-level signal.

When the two input terminals of the AND gate 3 are at the high level, the target valley position is determined, and the AND gate 3 outputs the valley on-state signal qr_on at the target valley position.

As illustrated in FIG. 2, influence of the change of the number of the valleys on the switching frequency and the primary side peak current Iₚₖ is described in detail below.

The number of the valleys is positively correlated with the off-time T_{off}. The longer the off-time T_{off} is, the larger the number of the valleys is.

The shorter the off-time T_{off} is, the smaller the number of the valleys is.

The switching cycle T_{SW}=Tₒₙ+T_{off}, and the switching frequency

$${F}_{SW} = \frac{1}{{T}_{SW}} ,$$

where Tₒₙ represents the on-time and T_{off} represents the off-time.

When the number of the valleys decreases, it means that the off-time T_{off} is shortened, the switching cycle T_{SW} is shortened, and the switching frequency F_{SW} is increased.

In addition, the calculation formula of power is

$$\frac{1}{2} {L}_{p} \times {F}_{SW} \times {I}_{pk}^{2} ,$$

where Lₚ represents the primary side winding inductance, F_{SW} represents the switching frequency, and Iₚₖ represents the primary side peak current.

When the valley number at Turn-on increases, the feedback loop of the switching power supply will increase the primary side peak current Iₚₖ. In this way, the feedback voltage V_{FB} increases, leading to a reduction in the off-time T_{off}, and a consistent power maintains prior to and subsequent to the valley switching.

When the valley number at Turn-on decreases, the feedback loop of the switching power supply will decrease the primary side peak current Iₚₖ. In this way, the feedback voltage V_{FB} decreases, leading to an increase in the off-time T_{off}, and the consistent power maintains prior to and subsequent the valley switching.

According to the power transistor control method provided in the embodiments of the present disclosure, the valley on-state position of the power transistor is adaptively adjusted based on the change of the feedback voltage (i.e., the change of the load). During a loop feedback adjustment process of a switching power supply, the erratic valley switching will not occur when the feedback voltage fluctuates, which enables the valley to be well locked, and solves the technical problems of frequency jitter due to the change of the voltage or load, and the large voltage ripple caused by the valley being locked too tightly.

A power transistor control system is further provided in the present disclosure.

The power transistor control system may be a switching power supply, for example, a flyback switching power supply.

As illustrated in FIG. 3, the power transistor control system may include a primary side control circuit 280, a feedback loop 300, a secondary side control circuit 290, a power transistor Q1, a primary side winding Np, an auxiliary winding Na, a secondary side winding Ns, a first sampling resistor R_{CS}, a second sampling resistor R1, a third sampling resistor R2, and a rectifier diode Q2.

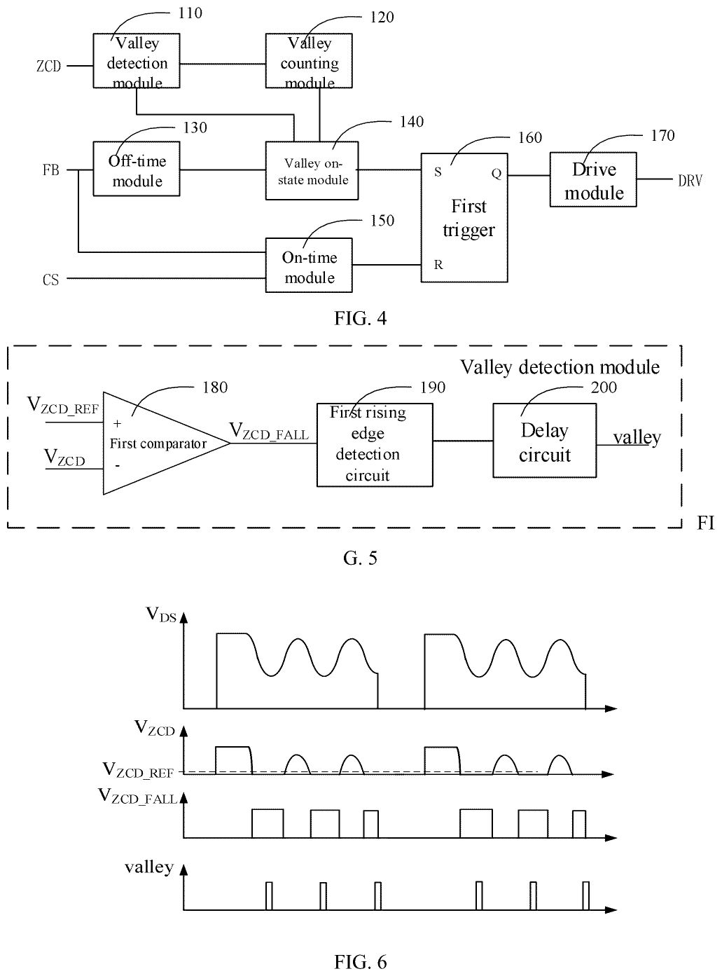

In this embodiment, a main structure of the primary side control circuit 280 is illustrated in FIG. 4. The primary side control circuit 280 may include a valley detection module 110, a valley counting module 120, an off-time module 130, a valley on-state module 140, an on-time module 150, a first trigger 160, and a drive module 170.

The primary side winding Np has a terminal connected to an input voltage Vin, and another terminal connected to a drain of the power transistor Q1.

A gate of the power transistor Q1 is connected to a DRV pin of the primary side control circuit 280.

A source of the power transistor Q1 is connected to a first sampling resistor R_{CS}, and another terminal of the first sampling resistor R_{CS} is grounded.

The terminal of the first sampling resistor R_{CS} connected to the source of power transistor Q1 is connected to a CS pin of the primary side control circuit 280.

The voltage on the auxiliary winding Na is in phase with a drain voltage of the power transistor Q1.

A dotted terminal of the auxiliary winding Na is connected to the second sampling resistor R1 and the third sampling resistor R2, and another terminal of the auxiliary winding Na is grounded.

A junction of the second sampling resistor R1 and the third sampling resistor R2 is connected to a ZCD pin of the primary side control circuit 280.

A dotted terminal of the secondary side winding Ns is connected to a drain of the rectifier diode Q2, and another terminal of the secondary side winding Ns is grounded.

A gate of the rectifier diode Q2 is connected to the secondary side control circuit 290, a source of the rectifier diode Q2 is connected to an output capacitor Cout, and another terminal of the output capacitor Cout is grounded.

An output voltage Vout is connected to a FB pin of the primary side control circuit 280 through the feedback loop 300.

As illustrated in FIG. 4, the power transistor control system includes the power transistor Q1, the valley detection module 110, the valley counting module 120, the off-time module 130, the valley on-state module 140, and the drive module 170.

In this embodiment, the power transistor Q1 may include a source, a drain, and a gate.

The valley detection module 110 is configured to output at least one valley signal.

In some embodiments, as illustrated in FIG. 5, the valley detection module 110 may include a first comparator 180, a first rising edge detection circuit 190, and a delay circuit 200.

In this embodiment, a non-inverting input of the first comparator 180 is connected to a first voltage threshold V_{ZCD_REF}, an inverting input of the first comparator 180 is connected to the sampled voltage signal V_{ZCD}, and an output terminal of the first comparator 180 is connected to the rising edge detection circuit.

The first rising edge detection circuit 190 is connected to the delay circuit 200.

When the power transistor Q1 is turned on, the first comparator 180 does not work, and an output of the first comparator 180 remains constantly 0.

When the power transistor Q1 is turned off, an enable signal EN is at a high level, and the first comparator 180 works.

When the sampled voltage signal V_{ZCD} drops below the first voltage threshold V_{ZCD_REF}, an output V_{ZCD FALL} of the first comparator 180 flips to a high level, and the V_{ZCD FALL} is output to the rising edge detection circuit.

When the first rising edge detection circuit 190 detects a rising edge of the V_{ZCD FALL}, the first rising edge detection circuit 190 outputs an intermediate pulse signal, and outputs the intermediate pulse signal to the post-stage delay circuit 200.

The delay circuit 200 delays the intermediate pulse signal to a resonant valley position and outputs the valley signal valley, as illustrated in FIG. 6.

The signal V_{ZCD FALL} changes with the resonant voltage V_{DS}.

The valley counting module 120 is connected to the valley detection module 110, and is configured to output the valley latching signal and the valley number at Turn-on corresponding to the target switching cycle.

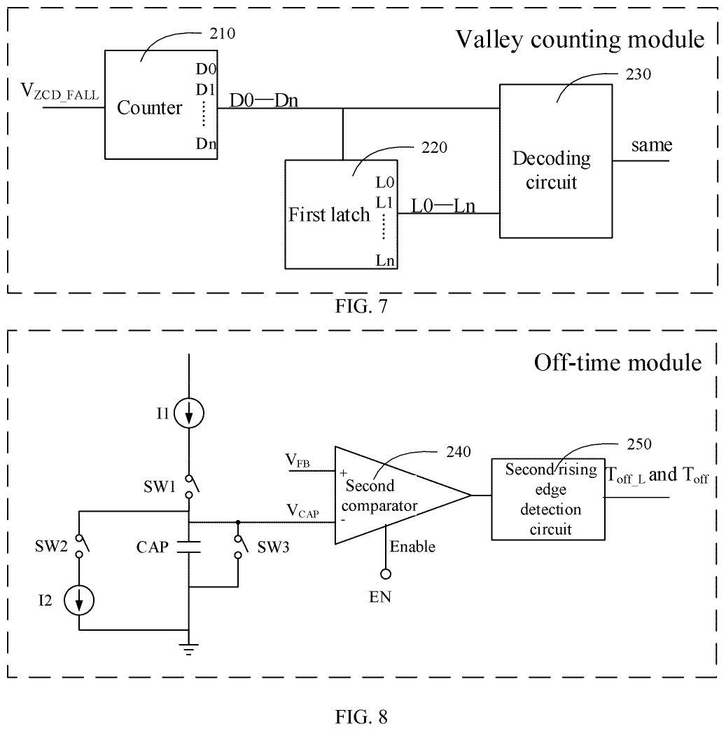

As illustrated in FIG. 7, in some embodiments, the valley counting module 120 includes a counter 210, a first latch 220, and a decoding circuit 230.

In this embodiment, the counter 210 is connected to the valley detection module 110.

The counter 210 is configured to receive the signal V_{ZCD FALL}, and convert high-low level transitions of the V_{ZCD FALL} into a counting signal Dn-D0.

For example, when a current resonant voltage V_{DS} resonates to the first valley, the counting signal Dn-D0 is 000 . . . 001; and when the current resonant voltage V_{DS} resonates to the second valley, the counting signal Dn-D0 is 000 . . . 010.

The counting signal Dn-D0 may represent 2ⁿ⁺¹ valleys.

The counting signal Dn-D0 is fed to the first latch 220, in such a manner that a signal Ln-L0 corresponding to the counting signal, generated by the first latch 220, may be obtained. The signal Ln-L0 may also represent 2ⁿ⁺¹ valleys.

The signal Dn-D0 may indicate the number of the valleys of the target switching cycle, and the signal Ln-L0 may indicate the number of the valleys of a previous cycle of the target switching cycle.

The signal Dn-D0 and the signal Ln-L0 are output to the decoding circuit 230, in such a manner that the decoding circuit 230 may compare the input counting signal.

When the number of valleys in a current resonant cycle is the same as that in a previous resonant cycle, the decoding circuit 230 outputs the valley latching signal same and feeds the valley latching signal same to the valley on-state module 140.

The off-time module 130 is configured to receive the feedback voltage, and output the off-time signal based on the feedback voltage.

As illustrated in FIG. 8, in some embodiments, the off-time module 130 may include a first switch SW1, a second switch SW2, a third switch SW3, a first current source I1, a second current source I2, a first capacitor CAP, a second comparator 240, and a second rising edge detection circuit 250.

In this embodiment, when the power transistor Q1 is turned off, the first switch SW1 is turned on, the first current source I1 charges the first capacitor CAP, and the second switch SW2 is turned on subsequent to the first capacitor CAP reaching a maximum value V_{CAP_MAX}.

A discharge current of the second current source 12 is greater than a charge current of the first current source I1, and the voltage V_{CAP} gradually decreases.

When the enable signal EN is at the high level, the second comparator 240 works normally.

When the enable signal EN is at the low level, an output of the second comparator 240 remains constantly 0.

When the voltage V_{CAP} is lower than the feedback voltage V_{FB}, an output of the second comparator 240 flips to high, and subsequent to passing through the second rising edge detection circuit 250, the off-time signal V_{off} (the second waveform signal) is generated.

At a position prior to the second waveform signal V_{off} by T_{delay}, the output of the second comparator 240 also passes through the second rising edge detection circuit 250 to generate the first waveform signal V_{off_L}.

Subsequent to the output of the second comparator 240 flipping to high, the first switch SW1 and the second switch SW2 are turned off, and the third switch SW3 is turned on to discharge and reset the first capacitor CAP.

The off-time is inversely proportional to the feedback voltage V_{FB}, meaning that the larger the feedback voltage V_{FB}, the shorter the off-time.

Operating waveforms of the signals corresponding to the off-time module 130 are illustrated in FIG. 9. When the feedback voltage V_{FB} continuously decreases to V_{FB_MIN}, the off-time is the longest. The longest off-time represents a minimum frequency limit.

When the feedback voltage V_{FB} continuously increases and exceeds V_{CAP MAX}, the off-time will not decrease further even if the feedback voltage V_{FB} continues to increase. The minimum off-time is determined based on V_{CAP MAX}, and the minimum off-time indicates the maximum frequency limit.

The valley on-state module 140 is connected to each of the valley detection module 110, the valley counting module 120, and the off-time module 130. The valley on-state module 140 is configured to determine the target valley position.

As illustrated in FIG. 14, in some embodiments, the valley on-state module 140 may include the latch 1, the latch 2, the AND gate 1, the AND gate 2, the delay circuit 1, the combination logic circuit 1, a second trigger 310, the OR gate 1, the OR gate 2, and an OR gate 3.

In this embodiment, the latch 1 is configured to receive the second waveform signal V_{off}, generate the second latching signal V_{off_latch} corresponding to the second waveform signal based on the second waveform signal V_{off}, and output the second latching signal V_{off_latch} to the delay circuit 1 to generate the delay signal V_{off_d}.

The second latching signal V_{off_latch} and the valley latching signal same are fed to the AND gate 1. When both the second latching signal V_{off_latch} and the valley latching signal same are high, the AND gate 1 outputs a high level and feed an output result of the AND gate 1 to the OR gate 1.

The latch 2 is configured to receive the first waveform signal V_{off_L} and generate the first latching signal V_{off_latch} based on the first waveform signal V_{off_L}. Subsequently, the first latching signal V_{off_latch} and the valley latching signal same are fed to the AND gate 2. When both the first latching signal V_{off_latch} and the valley latching signal same are high, the AND gate 2 outputs a high level, and feeds an output of the AND gate 2 to the OR gate 1.

An output of the OR gate 1 is fed to an input terminal of the OR gate 2.

The delay signal V_{off_d} and the valley counting signal D0-Dn in a current cycle are fed to the combination logic circuit 1. When the valley counting signal D0-Dn in the current cycle indicates that the current number of the valleys is 1 and the delay signal V_{off_d} is also high at this time, the combination logic circuit 1 outputs a high-level signal.

An output of the combination logic circuit 1 is fed to the input terminal of the OR gate 2.

The second trigger 310 may be a D-type trigger.

The second latching signal V_{off_latch} is fed to an input terminal of the second trigger 310. The second trigger 310 samples at the falling edge of the valley signal valley. That is, when the falling edge of the valley signal valley arrives, the second trigger 310 outputs the signal V_{off}_{ₛₐₘₚₗₑ}. The output of the second trigger 310 will be reset to 0 during the on-state of the power transistor Q1, and the signal V_{off}_{ₛₐₘₚₗₑ} output by the second trigger 310 is fed to the input terminal of the OR gate 2.

When any one of three input signals of the OR gate 2 is at a high level, the OR gate 2 outputs a high level.

The output of the OR gate 2 and the valley signal valley are fed to the input terminal of the AND gate 3. When both the OR gate 2 and the valley signal valley are at a high level, the AND gate 3 generates the valley on-state signal qr_on.

The valley on-state signal qr_on is input to an S terminal of the first trigger 160 illustrated in FIG. 4, in such a manner that a Q terminal of the first trigger 160 is high, and a DRV signal is high through a subsequent drive module 170, controlling the power transistor Q1 to be turned on.

As illustrated in FIG. 3 and FIG. 4, the drive module 170 is electrically connected to the valley on-state module 140 and the power transistor Q1.

The drive module 170 is configured to control the power transistor Q1 to be turned on at the target valley position.

The drive module 170 may further control the power transistor Q1 to be turned off based on the off-time signal.

The first trigger 160 includes a first input terminal S, a second input terminal R, and an output terminal Q.

The first input terminal S is connected to the valley on-state module 140.

The second input terminal R is connected to the on-time module 150.

The output terminal Q is connected to the drive module 170.

The first trigger 160 is configured to output a high-level signal based on the valley on-state signal and is further configured to output a low-level signal based on the off-signal.

The first trigger 160 may be a RS trigger.

In some embodiments, the power transistor control system may further include the on-time module 150.

In this embodiment, the on-time module 150 is connected to the off-time module 130.

The on-time module 150 is configured to output the off-time signal.

As illustrated in FIG. 10, in some embodiments, the on-time module 150 may include a third comparator 260 and a logic circuit 270.

In this embodiment, a positive input terminal of the third comparator 260 is

connected to the feedback voltage V_{FB}, and a negative input terminal of the third comparator 260 is connected to the primary side current signal V_{CS}.

An operating waveform corresponding to the on-time module 150 is illustrated in FIG. 11. When the primary side current I_{PKP} continues to increase to V_{CS} and exceeds the feedback voltage V_{FB}, an output of the third comparator 260 flips, and generates an off-signal Gate_off through a subsequent logic circuit 270.

The off-signal Gate_off is input to the R terminal of the first trigger 160 to enable the Q terminal of the first trigger 160 to output a low-level signal. Subsequent to passing through the drive module 170, the DRV signal is low, and the power transistor Q1 is controlled to be turned off.

When the power transistor Q1 is turned off, the secondary side current I_{PKS} begins to decrease. Subsequent to the secondary side current I_{PKS} decreasing to 0, the LC circuit formed by the primary side inductance and the parasitic capacitance of the primary side power transistor Q1 begins to resonate.

With the power transistor control system according to an embodiment of the present disclosure, the valley detection module 110, the valley counting module 120, the off-time module 130, the valley on-state module 140, and the drive module 170 are provided in the power transistor control system, at least one valley signal in the target switching cycle may be obtained based on the valley detection module 110, and the valley latching signal may be obtained through the valley counting module 120. In this way, the on-state position of the power transistor is determined based on the change of the feedback voltage and the change of the start time point of different signals, in such a manner that the power transistor may be turned on at the target valley position, and the valley may be accurately locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently prolongs the service life of the device.

The power transistor control apparatus provided in the present disclosure is described below. The power transistor control apparatus described below and the power transistor control method described above may refer to each other.

The executor of the power transistor control method provided in the embodiments of the present disclosure may be the power transistor control apparatus. In an embodiment of the present disclosure, the power transistor control apparatus executing the power transistor control method is taken as an example to illustrate the power transistor control apparatus provided in the embodiment of the present disclosure.

A power transistor control apparatus is further provided in the embodiments of the present disclosure.

As illustrated in FIG. 20, the power transistor control apparatus includes a first processing module 2010, a second processing module 2020, a third processing module 2030, a fourth processing module 2040, and a fifth processing module 2050.

The first processing module 2010 is configured to obtain the feedback voltage of the load corresponding to the power transistor, and obtain at least one valley signal and the valley latching signal in the target switching cycle when the power transistor is turned off. Each of the at least one valley signal indicates that the waveform resonance of the resonant voltage reaches the valley position. The target switching cycle is determined based on the feedback voltage.

The second processing module 2020 is configured to determine, based on the feedback voltage, the corresponding off-time signal of the power transistor in the target switching cycle. The off-time signal includes the first waveform signal and the second waveform signal. The second waveform signal is delayed by the target phase difference relative to the first waveform signal in the target switching cycle. The target phase difference is determined based on the feedback voltage.

The third processing module 2030 is configured to determine the target valley position based on the relationship between the start time point of at least one of the first waveform signal or the second waveform signal in the target switching cycle and the start time point of the valley latching signal in the target switching cycle when the feedback voltage decreases.

The fourth processing module 2040 is configured to determine the target valley position based on the relationship between the start time point of at least one of the first waveform signal or the second waveform signal in the target switching cycle and the start time point of each of the at least one valley signal in the target switching cycle when the feedback voltage increases.

The fifth processing module 2050 is configured to control the power transistor to be turned on at the target valley position.

With the power transistor control apparatus according to the embodiments of the present disclosure, when the feedback voltage changes differently, whether the on-state position of the power transistor changes is determined based on the change of the start time point of different signals, and the valley may be accurately locked, which solves the technical problems of frequency jitter due to the change of the voltage or the load, and the large voltage ripple caused by the valley being locked too tightly. Also, the power transistor is prevented from alternately being turned on at the adjacent valleys due to the change of the input voltage or the load, which reduces the device loss and subsequently prolongs the service life of the device.

In some embodiments, the third processing module 2030 may further be configured to: when the feedback voltage decreases, prolong the off-time, and shift backward the start time point of at least one of the first waveform signal or the second waveform signal in the target switching cycle; and determine the target valley position based on the relationship between the start time point of at least one of the backward-shifted first waveform signal or the backward-shifted second waveform signal in the target switching cycle and the start time point of the valley latching signal in the target switching cycle.

In some embodiments, the third processing module 2030 may further be configured to: when the valley number at Turn-on corresponding to the target switching cycle is n, n being the integer greater than or equal to 1, and when the start time point of at least one of the first waveform signal or the second waveform signal in the target switching cycle is prior to the valley latching signal, determine the valley position corresponding to the n-th valley signal among n valley signals as the target valley position, in which the valley corresponding to the n-th valley signal is the initial on-state valley of the switching power supply; and when the valley number at Turn-on corresponding to the target switching cycle changes from n to n+1, and when the start time point of at least one of the first waveform signal or the second waveform signal in the target switching cycle is subsequent to the valley latching signal, determine the valley position corresponding to the (n+1)-th valley signal among n+1 valley signals as the target valley position, and latch the valley corresponding to the (n+1)-th valley signal.

In some embodiments, the power transistor control apparatus may further includes a sixth processing module. The sixth processing module is configured to: subsequent to determining the valley position corresponding to the (n+1)-th valley signal among the n+1 valley signals as the target valley position, and latching the valley corresponding to the (n+1)-th valley signal, when the feedback voltage increases, the valley number at Turn-on is n+1, and the start time point of the first waveform signal in the target switching cycle is prior to the valley latching signal, determine the valley position corresponding to the (n+1)-th valley signal as the target valley position.

In some embodiments, the fourth processing module 2040 may further configured to: when the feedback voltage increases, shorten the off-time, and shift forward the start time point of the first waveform signal in the target switching cycle and the start time point of the second waveform signal in the target switching cycle; and determine the target valley position based on the relationship between the start time point of at least one of the forward-shifted first waveform signal or the forward-shifted second waveform signal in the target switching cycle and the start time point of each of the at least one valley signal in the target switching cycle.

In some embodiments, the fourth processing module 2040 may further configured to: when the valley number at Turn-on corresponding to the target switching cycle is m+1, m being the integer greater than or equal to 1, and when the start time point of the first waveform signal in the target switching cycle is prior to the (m-1)-th valley signal among m+1 valley signals, and the start time point of the second waveform signal in the target switching cycle is subsequent to the (m-1)-th valley signal, determine the valley position corresponding to the (m+1)-th valley signal among the m+1 valley signals as the target valley position, in which the valley corresponding to the (m+1)-th valley signal is the initial on-state valley of the switching power supply; and when the valley number at Turn-on corresponding to the target switching cycle changes from m+1 to m, and when the start time point of the first waveform signal in the target switching cycle and the start time point of the second waveform signal in the target switching cycle are both prior to the (m-1)-th valley signal, determine the valley position corresponding to the m-th valley signal among m valley signals as the target valley position, and latch the valley corresponding to the m-th valley signal.

In some embodiments, the power transistor control apparatus may further include a seventh processing module configured to: subsequent to determining the valley position corresponding to the m-th valley signal among the m valley signals as the target valley position and latching the valley corresponding to the m-th valley signal, when the feedback voltage decreases, the valley number at Turn-on is m, the start time point of the first waveform signal in the target switching cycle is prior to the (m-1)-th valley signal among the m valley signals, and the start time point of the second waveform signal in the target switching cycle is subsequent to the (m-1)-th valley signal among the m valley signals, determine the valley position corresponding to the m-th valley signal as the target valley position.

In some embodiments, the fourth processing module 2040 may further be configured to: obtain the delay signal corresponding to the second waveform signal; when the valley number at Turn-on corresponding to the target switching cycle is 2, and the start time point of the delay signal in the target switching cycle is prior to the valley position corresponding to the second valley signal, determine the valley position corresponding to the second valley signal as the target valley position, in which the valley corresponding to the second valley signal is the initial on-state valley of the switching power supply; and when the valley number at Turn-on corresponding to the target switching cycle changes from 2 to 1, and the start time point of the delay signal in the target switching cycle is prior to the valley position corresponding to the first valley signal, determine the valley position corresponding to the first valley signal as the target valley position, and latch the target valley position.

In some embodiments, the power transistor control apparatus may further include an eighth processing module configured to: obtain the off-signal when the first voltage signal corresponding to the primary side current is greater than the feedback voltage; and control the power transistor to be turned off based on the off-signal.

In some embodiments, the first processing module 2010 may further be configured to: obtain the first quantity corresponding to the at least one valley signal in the target switching cycle and the second quantity corresponding to at least one valley signal in the previous cycle of the target switching cycle; and obtain the valley latching signal when the first quantity is equal to the second quantity.

The power transistor control apparatus in the embodiments of the present disclosure may be an electronic device or a component in the electronic device, such as an integrated circuit or a chip. The electronic device may be a terminal, or other devices other than the terminal. Exemplarily, the electronic device may be a mobile phone, a tablet computer, a notebook computer, a palmtop computer, an in-vehicle electronic device, a Mobile Internet Device (MID), an augmented reality (AR)/virtual reality (VR) device, a robot, a wearable device, an ultra-mobile personal computer (UMPC), a netbook or a personal digital assistant (PDA), etc., or may be a server, a Network Attached Storage (NAS), a personal computer (PC), a television (TV), a teller machine or a self-service machine, etc., which is not specifically limited in the embodiments of the present disclosure.

The power transistor control apparatus in the embodiments of the present disclosure may be an apparatus having an operating system. The operating system may be an Android operating system, an IOS operating system, or other possible operating systems, which is not specifically limited in the embodiments of the present disclosure.

The power transistor control apparatus provided in the embodiments of the present disclosure is capable of implementing each process implemented by the method embodiments illustrated in FIG. 1 to FIG. 19. To avoid repetition, detailed descriptions are omitted herein.

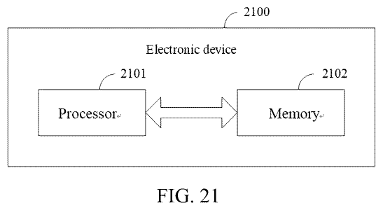

In some embodiments, as illustrated in FIG. 21, the embodiments of the present disclosure also provide an electronic device 2100, including a processor 2101, a memory 2102, and a computer program stored in the memory 2102 and executable by the processor 2101. The computer program, when executed by the processor 2101, implements each process of the above-described power transistor control method embodiments, and the same technical effects may be achieved. To avoid repetition, detailed descriptions are omitted herein.

It should be noted that, the electronic device in the embodiments of the present disclosure includes the above-described mobile electronic device and non-mobile electronic device.

In another aspect, the present disclosure further provides a computer program product including a computer program stored on a non-transitory computer-readable storage medium. The computer program includes program instructions. When the program instructions are executed by a computer, the computer is capable of executing each process of the above-described power transistor control method embodiments and achieving the same technical effects. To avoid repetition, detailed descriptions are not omitted herein.

In yet another aspect, the embodiments of the present disclosure further provide a non-transitory computer-readable storage medium having a computer program stored thereon. The computer program, when executed by a processor, implements each process of the above-described power transistor control method embodiments. The same technical effects may be achieved. To avoid repetition, detailed descriptions are omitted herein.

In still another aspect, the embodiments of the present disclosure further provide a chip including a processer and a communication interface coupled to the processor. The processor is configured to execute a program or instructions to implement each process of the above-described power transistor control method embodiments. The same effects may be achieved. To avoid repetition, detailed descriptions are omitted herein.

It should be noted that, the chip mentioned in the embodiments of the present disclosure may also be called a System-on-Chip, a system-level chip, a system chip, a chip system, or an on-chip system chip, etc.

What is claimed is:

1. A power transistor control method, comprising:
obtaining a feedback voltage of a load corresponding to a power transistor, and obtaining at least one valley signal and a valley latching signal in a target switching cycle when the power transistor is turned off, wherein each of the at least one valley signal indicates that waveform resonance of a resonant voltage reaches a valley position, and the target switching cycle is determined based on the feedback voltage;
determining, based on the feedback voltage, a corresponding off-time signal of the power transistor in the target switching cycle, wherein the off-time signal comprises a first waveform signal and a second waveform signal, the second waveform signal is delayed by a target phase difference relative to the first waveform signal in the target switching cycle, and the target phase difference is determined based on the feedback voltage;
when the feedback voltage decreases, determining a target valley position based on a relationship between a start time point of at least one of the first waveform signal or the second waveform signal in the target switching cycle and a start time point of the valley latching signal in the target switching cycle;
when the feedback voltage increases, determining the target valley position based on a relationship between the start time point of at least one of the first waveform signal or the second waveform signal in the target switching cycle and a start time point of each of the at least one valley signal in the target switching cycle; and
controlling the power transistor to be turned on at the target valley position.

2. The power transistor control method according to claim 1, comprising:
when the feedback voltage decreases, prolonging off-time, and shifting backward the start time point of at least one of the first waveform signal or the second waveform signal in the target switching cycle;
when a valley number at Turn-on corresponding to the target switching cycle is n, n being an integer greater than or equal to 1, and when the start time point of at least one of the first waveform signal or the second waveform signal in the target switching cycle is prior to the valley latching signal, determining a valley position corresponding to an n-th valley signal among n valley signals as the target valley position, the valley corresponding to the n-th valley signal being an initial on-state valley of a switching power supply; and
when the valley number at Turn-on corresponding to the target switching cycle changes from n to n+1, and when the start time point of at least one of the first waveform signal or the second waveform signal in the target switching cycle is subsequent to the valley latching signal, determining a valley position corresponding to an (n+1)-th valley signal among n+1 valley signals as the target valley position, and latching the valley corresponding to the (n+1)-th valley signal.

3. The power transistor control method according to claim 2, wherein subsequent to said determining the valley position corresponding to the (n+1)-th valley signal among the n+1 valley signals as the target valley position, and latching the valley corresponding to the (n+1)-th valley signal, the power transistor control method further comprises:
when the feedback voltage increases, the valley number at Turn-on is n+1, and a start time point of the first waveform signal in the target switching cycle is prior to the valley latching signal, determining the valley position corresponding to the (n+1)-th valley signal as the target valley position.

4. The power transistor control method according to claim 1, comprising:
when the feedback voltage increases, shortening off-time, and shifting forward a start time point of the first waveform signal in the target switching cycle and a start time point of the second waveform signal in the target switching cycle;
when a valley number at Turn-on corresponding to the target switching cycle is m+1, m being an integer greater than or equal to 1, and when the start time point of the first waveform signal in the target switching cycle is prior to an (m-1)-th valley signal among m+1 valley signals, and the start time point of the second waveform signal in the target switching cycle is subsequent to the (m-1)-th valley signal, determining a valley position corresponding to an (m+1)-th valley signal among the m+1 valley signals as the target valley position, the valley corresponding to the (m+1)-th valley signal being an initial on-state valley of a switching power supply; and
when the valley number at Turn-on corresponding to the target switching cycle changes from m+1 to m, and when the start time point of the first waveform signal in the target switching cycle and the start time point of the second waveform signal in the target switching cycle are both prior to the (m-1)-th valley signal, determining a valley position corresponding to an m-th valley signal among m valley signals as the target valley position, and latching the valley corresponding to the m-th valley signal.

5. The power transistor control method according to claim 4, wherein subsequent to said determining the valley position corresponding to the m-th valley signal among the m valley signals as the target valley position, and latching the valley corresponding to the m-th valley signal, the power transistor control method further comprises:
determining the valley position corresponding to the m-th valley signal as the target valley position when the feedback voltage decreases, the valley number at Turn-on is m, the start time point of the first waveform signal in the target switching cycle is prior to the (m-1)-th valley signal among the m valley signals, and the start time point of the second waveform signal in the target switching cycle is subsequent to the (m-1)-th valley signal among the m valley signals.

6. The power transistor control method according to claim 1, comprising:
obtaining a delay signal corresponding to the second waveform signal;
when a valley number at Turn-on corresponding to the target switching cycle is 2, and a start time point of the delay signal in the target switching cycle is prior to a valley position corresponding to a second valley signal, determining the valley position corresponding to the second valley signal as the target valley position, the valley corresponding to the second valley signal being an initial on-state valley of a switching power supply; and
when the valley number at Turn-on corresponding to the target switching cycle changes from 2 to 1, and the start time point of the delay signal in the target switching cycle is prior to a valley position corresponding to a first valley signal, determining the valley position corresponding to the first valley signal as the target valley position, and latching the target valley position.

7. The power transistor control method according to claim 1, wherein subsequent to said obtaining the feedback voltage of the load corresponding to the power transistor, the power transistor control method further comprises:
obtaining an off-signal when a first voltage signal corresponding to a primary side current is greater than the feedback voltage; and
controlling the power transistor to be turned off based on the off-signal.

8. The power transistor control method according to claim 1, comprising:
obtaining a first quantity corresponding to the at least one valley signal in the target switching cycle and a second quantity corresponding to at least one valley signal in a previous cycle of the target switching cycle; and
obtaining the valley latching signal when the first quantity is equal to the second quantity.

9. A power transistor control system based on the power transistor control method according to claim 1, comprising:
a valley detection module configured to output at least one valley signal;
a valley counting module connected to the valley detection module, wherein the valley counting module is configured to output a valley latching signal and a valley number at Turn-on corresponding to a target switching cycle;
an off-time module configured to receive a feedback voltage, and output an off-time signal based on the feedback voltage;
a valley on-state module connected to each of the valley detection module, the valley counting module, and the off-time module, wherein the valley on-state module is configured to determine a target valley position;
a power transistor; and
a drive module electrically connected to each of the valley on-state module and the power transistor, wherein the drive module is configured to control the power transistor to be turned on at the target valley position.

10. The power transistor control system according to claim 9, further comprising:
an on-time module connected to the off-time module, wherein the on-time module is configured to output an off-signal, and the drive module is further configured to control the power transistor to be turned off based on the off-signal; and
a first trigger comprising a first input terminal, a second input terminal, and an output terminal, wherein the first input terminal is connected to the valley on-state module, the second input terminal is connected to the on-time module, and the output terminal is connected to the drive module; and wherein the first trigger is configured to output a high-level signal based on a valley on-state signal and output a low-level signal based on the off-signal.

11. An electronic device, comprising a memory, a processor, and a computer program stored in the memory and executable by the processor, wherein the processor, when executing the computer program, implements a power transistor control method, the power transistor control method comprising:
obtaining a feedback voltage of a load corresponding to a power transistor, and obtaining at least one valley signal and a valley latching signal in a target switching cycle when the power transistor is turned off, wherein each of the at least one valley signal indicates that waveform resonance of a resonant voltage reaches a valley position, and the target switching cycle is determined based on the feedback voltage;
determining, based on the feedback voltage, a corresponding off-time signal of the power transistor in the target switching cycle, wherein the off-time signal comprises a first waveform signal and a second waveform signal, the second waveform signal is delayed by a target phase difference relative to the first waveform signal in the target switching cycle, and the target phase difference is determined based on the feedback voltage;
when the feedback voltage decreases, determining a target valley position based on a relationship between a start time point of at least one of the first waveform signal or the second waveform signal in the target switching cycle and a start time point of the valley latching signal in the target switching cycle;
when the feedback voltage increases, determining the target valley position based on a relationship between the start time point of at least one of the first waveform signal or the second waveform signal in the target switching cycle and a start time point of each of the at least one valley signal in the target switching cycle; and
controlling the power transistor to be turned on at the target valley position.

12. The electronic device according to claim 11, the power transistor control method comprising:
when the feedback voltage decreases, prolonging off-time, and shifting backward the start time point of at least one of the first waveform signal or the second waveform signal in the target switching cycle;
when a valley number at Turn-on corresponding to the target switching cycle is n, n being an integer greater than or equal to 1, and when the start time point of at least one of the first waveform signal or the second waveform signal in the target switching cycle is prior to the valley latching signal, determining a valley position corresponding to an n-th valley signal among n valley signals as the target valley position, the valley corresponding to the n-th valley signal being an initial on-state valley of a switching power supply; and
when the valley number at Turn-on corresponding to the target switching cycle changes from n to n+1, and when the start time point of at least one of the first waveform signal or the second waveform signal in the target switching cycle is subsequent to the valley latching signal, determining a valley position corresponding to an (n+1)-th valley signal among n+1 valley signals as the target valley position, and latching the valley corresponding to the (n+1)-th valley signal.

13. The electronic device according to claim 12, wherein subsequent to said determining the valley position corresponding to the (n+1)-th valley signal among the n+1 valley signals as the target valley position, and latching the valley corresponding to the (n+1)-th valley signal, the power transistor control method further comprises:
when the feedback voltage increases, the valley number at Turn-on is n+1, and a start time point of the first waveform signal in the target switching cycle is prior to the valley latching signal, determining the valley position corresponding to the (n+1)-th valley signal as the target valley position.

14. The electronic device according to claim 11, the power transistor control method comprising:
when the feedback voltage increases, shortening off-time, and shifting forward a start time point of the first waveform signal in the target switching cycle and a start time point of the second waveform signal in the target switching cycle;
when a valley number at Turn-on corresponding to the target switching cycle is m+1, m being an integer greater than or equal to 1, and when the start time point of the first waveform signal in the target switching cycle is prior to an (m-1)-th valley signal among m+1 valley signals, and the start time point of the second waveform signal in the target switching cycle is subsequent to the (m-1)-th valley signal, determining a valley position corresponding to an (m+1)-th valley signal among the m+1 valley signals as the target valley position, the valley corresponding to the (m+1)-th valley signal being an initial on-state valley of a switching power supply; and
when the valley number at Turn-on corresponding to the target switching cycle changes from m+1 to m, and when the start time point of the first waveform signal in the target switching cycle and the start time point of the second waveform signal in the target switching cycle are both prior to the (m-1)-th valley signal among m valley signals, determining a valley position corresponding to an m-th valley signal as the target valley position, and latching the valley corresponding to the m-th valley signal.

15. The electronic device according to claim 14, wherein subsequent to said determining the valley position corresponding to the m-th valley signal among the m valley signals as the target valley position, and latching the valley corresponding to the m-th valley signal, the power transistor control method further comprises:
determining the valley position corresponding to the m-th valley signal as the target valley position when the feedback voltage decreases, the valley number at Turn-on is m, the start time point of the first waveform signal in the target switching cycle is prior to the (m-1)-th valley signal among the m valley signals, and the start time point of the second waveform signal in the target switching cycle is subsequent to the (m-1)-th valley signal among the m valley signals.

16. The electronic device according to claim 11, the power transistor control method comprising:
obtaining a delay signal corresponding to the second waveform signal;
when a valley number at Turn-on corresponding to the target switching cycle is 2, and a start time point of the delay signal in the target switching cycle is prior to a valley position corresponding to a second valley signal, determining the valley position corresponding to the second valley signal as the target valley position, the valley corresponding to the second valley signal being an initial on-state valley of a switching power supply; and
when a valley number at Turn-on corresponding to the target switching cycle changes from 2 to 1, and the start time point of the delay signal in the target switching cycle is prior to a valley position corresponding to a first valley signal, determining the valley position corresponding to the first valley signal as the target valley position, and latching the target valley position.

17. The electronic device according to claim 11, wherein subsequent to said obtaining the feedback voltage of the load corresponding to the power transistor, the power transistor control method further comprises:
obtaining an off-signal when a first voltage signal corresponding to a primary side current is greater than the feedback voltage; and
controlling the power transistor to be turned off based on the off-signal.

18. The electronic device according to claim 11, the power transistor control method comprising:
obtaining a first quantity corresponding to the at least one valley signal in the target switching cycle and a second quantity corresponding to at least one valley signal in a previous cycle of the target switching cycle; and
obtaining the valley latching signal when the first quantity is equal to the second quantity.

19. A non-transitory computer-readable storage medium having a computer program stored thereon, wherein the computer program, when executed by a processor, implements a power transistor control method, the power transistor control method comprising:
obtaining a feedback voltage of a load corresponding to a power transistor, and obtaining at least one valley signal and a valley latching signal in a target switching cycle when the power transistor is turned off, wherein each of the at least one valley signal indicates that waveform resonance of a resonant voltage reaches a valley position, and the target switching cycle is determined based on the feedback voltage;
determining, based on the feedback voltage, a corresponding off-time signal of the power transistor in the target switching cycle, wherein the off-time signal comprises a first waveform signal and a second waveform signal, the second waveform signal is delayed by a target phase difference relative to the first waveform signal in the target switching cycle, and the target phase difference is determined based on the feedback voltage;
when the feedback voltage decreases, determining a target valley position based on a relationship between a start time point of at least one of the first waveform signal or the second waveform signal in the target switching cycle and a start time point of the valley latching signal in the target switching cycle;
when the feedback voltage increases, determining the target valley position based on a relationship between the start time point of at least one of the first waveform signal or the second waveform signal in the target switching cycle and a start time point of each of the at least one valley signal in the target switching cycle; and
controlling the power transistor to be turned on at the target valley position.

20. The non-transitory computer-readable storage medium according to claim 19, the power transistor control method comprising:
when the feedback voltage decreases, prolonging off-time, and shifting backward the start time point of at least one of the first waveform signal or the second waveform signal in the target switching cycle;
when a valley number at Turn-on corresponding to the target switching cycle is n, n being an integer greater than or equal to 1, and when the start time point of at least one of the first waveform signal or the second waveform signal in the target switching cycle is prior to the valley latching signal, determining a valley position corresponding to an n-th valley signal among n valley signals as the target valley position, the valley corresponding to the n-th valley signal being an initial on-state valley of a switching power supply; and
when the valley number at Turn-on corresponding to the target switching cycle changes from n to n+1, and when the start time point of at least one of the first waveform signal or the second waveform signal in the target switching cycle is subsequent to the valley latching signal, determining a valley position corresponding to an (n+1)-th valley signal among n+1 valley signals as the target valley position, and latching the valley corresponding to the (n+1)-th valley signal.
